(19) United States
(12) Patent Application Publication
(10) Pub. No.: US 2015/0231876 A1
(43) Pub. Date: Aug. 20, 2015

(54) METHOD AND DEVICE FOR ALIGNING PRINTING PLATES ON PRINTING CYLINDERS

(71) Applicant: BALL EUROPE GMBH, Zurich (CH)

(72) Inventors: Wolfgang Kasper, Bonn (DE); Marcus Hack, Alfter (DE)

(21) Appl. No.: 14/421,593

(22) PCT Filed: Jun. 24, 2013
(86) PCT No.: PCT/EP2013/063139

§ 371 Date: Feb. 13, 2015

(30) Foreign Application Priority Data
Aug. 21, 2012 (DE) 10 2012 214 824.8

(51) Int. Cl. B41F 27/00

(52) U.S. Cl. CPC B41F 27/005

(57) ABSTRACT

The invention relates to a method and a device for aligning printing plates on printing cylinders to provide an image or indicia on metallic cylindrical containers.

The invention relates to a method and a device for aligning printing plates on printing cylinders. The invention relates in particular to a method and a device for aligning printing plates on printing cylinders of a printing press for printing the outer cylindrical surface of a body of a beverage can, in particular using a relief printing process.

The area of application of the invention relates in particular to the printing of beverage cans, in particular printing on the cylindrical printing surface of a beverage can, in particular one made from tin or aluminium having a printed image. A beverage can is here understood to mean the body of a beverage can having a base, a cylindrical wall and an open end opposite the base. Such beverage cans are usually grouped together into palettes and supplied to filling plants which fill the beverage can with a beverage through the open end, and the open end is sealed with a beverage can lid after filling so that a filled, sealed beverage container results. The open end of a beverage can is preferably drawn in and provided with a bent-out crimped rim so that a beverage can lid can be connected to the bent-out crimped rim of the open end of the beverage can by crimping. Beverage cans are preferably made from tin, steel or aluminium.

The printing of a beverage can is usually part of the overall manufacturing process for a beverage can. The overall manufacturing process for a beverage can comprises, in addition to the printing, usually cutting out a blank and deep-drawing a cup which is then ironed to form a can body, cutting or trimming the open end, washing the beverage cans in order to remove excess ironing lubricant, applying different coatings such as, for example, UV coatings and paint for the inside, outside and base, drying (possibly multiple times) after one or more process steps, drawing in the open end, and an inspection, for example to test for perforations and cracks in the rim, and palletization.

A printed image, which has a graphical design which is intended to appeal to a user, is preferably applied to the outer surface of the cylindrical wall of a beverage can, i.e. to a cylindrical printing surface. Alternatively or additionally, graphical elements of an informational nature, for example data on contents, deposit stamps, best-before or production dates, identification numbers or the like, can be arranged in the printed image.

Such a printed image is usually applied to the cylindrical printing surface of a beverage can using a printing process. It is known, for example, to print beverage cans using a relief printing process. To do this, printing presses with at least one but usually multiple printing cylinders on which printing plates are positioned are generally used. The cans which are to be printed are usually pulled by a vacuum onto mandrels, arranged in a circle, of an indexed rotary machine and set in rotation about their own axis. Individual inks are transferred by inking units via ink ducts, rollers and printing cylinders with printing plates or printing blankets arranged thereon. The printing plates, which can also be called relief printing blocks, receive ink from the inking unit providing the ink in each case only at those points at which they are raised and transfer this ink to the printing blanket. All the inks required for the printed image are applied to the printing blanket in a mirror image. A can carried by a mandrel rotates synchronously opposite the printing blanket and receives the printed image from the printing blanket. By rolling the can against the printing blanket, the inks of the printed image are transferred to the can and the printed image becomes positive.

In printing processes in which different printing plates are applied to different printing cylinders and the respective individual images generated by the individual printing plates are superposed to form an overall printed image, it is necessary to align the printing plates precisely on the printing cylinders in order to ensure a high-quality printed image. Just the smallest variations in the position of individual printing plates relative to one another can result in a printed image of inferior quality. Different methods are therefore known for aligning printing plates precisely on a printing cylinder.

When printing cans, because the end product is printed over essentially its whole surface, the so-called register accuracy, i.e. the precise relative alignment of the printing plates, cannot be measured with the aid of register marks or the like known from sheet-fed printing, arranged at sheet edges which are not part of the actual printed image, and cannot be corrected using such measured values. Instead, the register accuracy is determined qualitatively in a stepwise manner using trial prints and corrected by testing until the desired printed image results with the desired quality. The register accuracy is here also determined by the contact pressure of the printing blanket (rubber blanket) on the can which is to be printed. The compressive force required in each case here depends in turn on the respective printed image.

U.S. Pat. No. 5,065,677 discloses the alignment of a printing plate relative to a printing cylinder, wherein a reference point on the printing plate is detected by means of a camera and positioned by means of an aligning unit in a specific position relative to a rotatably mounted printing cylinder and applied to the latter. One or more printing plates can be applied in succession to the printing cylinder, wherein for each of the printing plates the respective reference point on the printing plate is detected, the printing plate is aligned with the aid of the reference point and is then applied to the printing cylinder. Lastly, a proof is produced by means of which the accuracy of the alignment of the printing plates can be checked.

EP 1 593 505 B1 discloses a method for quickly checking the position of a printed image on a printing forme, wherein the printing forme is provided with registration holes and, before positioning on a printing cylinder, is laid with the registration holes over register pins of a measuring arrangement. In this measuring arrangement, marks on the printing plate are then recorded by means of a camera and their position is saved. In this method, deviations of the printed image in relation to the registration holes are detected which are so great that they cannot be corrected once the printing plates have been laid onto the printing cylinder of the printing press. The data determined in the measuring arrangement serve (in the case of printing plates with acceptable deviations) to correct the position of the printing plates on the printing cylinders, for example by shifting corresponding register pins on the printing cylinders of the printing press, using a motor or by hand.

EP 1 826 004 A2 additionally provides that a transponder, in which the measurement data and possibly other data can be saved, is arranged on the printing plates so that each printing plate bears the data determined for it on the transponder and said data can be read even over relatively large distances contactlessly and with respect to the individual printing plate, and confusing the printing plates can also be avoided.

EP 2 106 910 B1 furthermore also records, in addition to tolerances and inaccuracies of the printing plate, position correction data of the plate or printing cylinder itself. The position correction data of the printing cylinder can be input into a computer device or be saved there.

In these existing methods, although the accuracy of the alignment of printing plates is increased, there is a need for further improvements. In particular, the existing methods have the disadvantage that they are very time-consuming. In particular, the greater reduction in the batch size for printing beverage cans with a specific printed image increases the number of times the printed image or pattern is changed. Because, during such changes of the printed image or pattern on a printing press, the whole manufacturing process for beverage cans often needs to be stopped or at least considerably restricted, it is desirable to reduce the time required to change a printed image or pattern. In addition to the time required to change a printed image or pattern, it should also be noted that there is a high degree of wastage of cans with a suboptimal printed image because frequent test prints are necessary until the different printing plates are registered in order to achieve a printed image with acceptable quality standards. Even when a printed image needs to be printed again at a later point in time which has already been printed once in a previous batch, repeated alignment of the printing plates on the printing cylinders with corresponding wastage and a correspondingly long time to change the printed image or pattern are required. Moreover, adjusting the printing plate cylinder can represent a cause of accidents for employees.

An object of the present invention is therefore to provide a method and a device for aligning printing plates on printing cylinders which reduce or overcome one or more of the disadvantages mentioned. In particular, an object of the present invention is to provide a method and a device for aligning printing plates on printing cylinders which reduce the downtime caused by changing a printed image or pattern. Moreover, it is an object of the present invention to provide a method and a device for aligning printing plates on printing cylinders which represent an alternative to existing aligning methods and devices, and/or improve existing aligning methods and devices.

This object is achieved according to the invention by a method for aligning printing plates on printing cylinders outside a printing press, comprising the steps: determining predetermined first and second positions with the aid of previously determined printing-cylinder-specific correction values for a first and a second printing cylinder, arranging the first printing cylinder outside a printing press in a first holding position, providing a first printing plate, positioning the first printing plate on the first printing cylinder in a predetermined first position, recording first position data for the printing plate positioned on the first printing cylinder, arranging the second printing cylinder outside a printing press in accordance with a second holding position, providing a second printing plate, positioning the second printing plate relative to the second printing cylinder in a predetermined second position, recording second position data for the second printing plate positioned relative to the second printing cylinder, checking the first and second position data with the aid of the predetermined first and second position, if necessary correcting the positioning of the first and/or the second printing plate if the result of the check is negative.

With the said method, at least one correction value is thus first determined for each printing cylinder, which contains at least information on a respective individual precise alignment, which lies in the region of a fraction of a millimetre, for example in the region of 1/100 mm, of a respective printing cylinder in the respective printing unit.

The invention includes, inter alia, the insight that a considerable saving can be obtained for changing a printed image or pattern if the procedure for aligning the printing plates on the printing cylinders can be carried out outside the printing press. When sufficient printing cylinders are available for a printing press, in this way the printing press can be used in operation in a printing press, for example, with a first set of printing cylinders on which printing plates for a first printed image are arranged. Even during this ongoing printing procedure for a first printed image, printing plates for a second printed image can be arranged and aligned, for example, on a second set of printing cylinders outside the printing press. When the end of the batch with the first printed image is reached and the printed image or pattern needs to be changed, this can take place simply by replacing the first set of printing cylinders with the second set of printing cylinders. Because the printing plates are then already positioned and aligned on this second set of printing cylinders, the printing process can be started immediately after the second set of printing cylinders is installed without there being any need for further alignment work on the printing plates in the printing press. In this way, the time required to change a printed image or pattern can be reduced to the time required to install and remove the printing cylinder.

In particular, the time-consuming alignment of the printing plates inside the printing press and subsequent checking of the register can cease to apply.

A further insight on which the invention is based is that the printing plate is not aligned with respect to the printing cylinder and instead data about the position of the printing plates relative to one another are compared and if necessary the position is then corrected. Using existing solutions, these deviations in the relative positioning of the printing plates relative to one another can de detected only on the test print and the printing cylinders then need to be laboriously readjusted in the printing press, with the known disadvantages in terms of downtime and wastage. By comparing and if necessary correcting the relative position of the printing plates relative to one another as early as when the printing plates are applied to printing cylinders outside the printing press, the print quality can be significantly increased right from the first printing after the printing cylinders have been installed in the printing press, and hence the laborious readjustment can be avoided or at least reduced.

The individual steps of the method according to the invention and advantageous developments and optional embodiments are described below.

Printing-cylinder-specific correction values for a first and a second printing cylinder are first determined.

Predetermined first and second positions for the positioning of the first and second printing plates on the first and second printing cylinders are derived from these printing-cylinder-specific correction values. It is preferred that correction values for multiple printing cylinders, in particular all the printing cylinders of a printing press, are determined and predetermined positions for all the printing plates to be arranged on the printing cylinders are derived therefrom.

The printing-cylinder-specific correction values can contain printing-cylinder-specific correction data and in addition printing-plate-specific correction data can also influence the predetermined position. The term software-based correction can also be used to refer to such a process of taking into account correction values when aligning or positioning by means of a corresponding change in the predetermined position or the position of the printing plates.

Printing-cylinder-specific correction values can, for example, contain information on whether there is a so-called offset of a printing cylinder in the printing press relative to the holding position. It is possible, for example owing to wear, that an original position of a printing cylinder in a printing press changes over time and the actual position of the printing cylinder no longer coincides with this original position. If the holding position in which the printing cylinder is arranged before the process of aligning the printing plate begins then corresponds to the original position of the printing cylinder in the printing press, when the printing cylinder is installed in the printing press the alignment of the printing plate for the printing that then takes place is then not optimal because the printing cylinder has an offset in the printing press relative to its original position or the holding position. If information on such an offset, here referred to as a correction value, is determined before the printing plate is laid on the printing cylinder, the correction values can be used when aligning the printing plates by the predetermined position of a printing plate being changed according to the correction values. The holding position of the printing cylinder before the alignment of the printing plates here remains unchanged, but the printing plate is not placed in the original provided position which is aligned to the original position of the printing cylinder in the printing press and instead in a corrected predetermined position which takes into account the actual position of the printing cylinder in the printing press. In this way, current wear and offset values for the printing cylinders in a printing press can be taken into account and corrected as early as when the printing plates are positioned outside the printing press so that this correction can be made simply as part of the process of aligning the printing plates on the printing cylinders which takes place anyway. Subsequent correction of the positioning of the printing plates or the printing cylinders in the printing press is thus unnecessary.

The printing-cylinder-specific correction values can have mechanical causes and result from the printing press, and can, for example, take into account an offset resulting from wear in the cylinder holders or changes caused by replacing inking units. In addition, printing-cylinder-specific correction values can also have processing causes which can result, for example, from the contact pressure values (dependent on the specific printing area), the quantity of ink to be applied, the printing speed or the printing blanket (rubber blanket) used. The printing-cylinder-specific correction values are preferably stored in a database.

It is moreover possible to determine multiple different correction values for each printing cylinder, and for example to store multiple virtual printing cylinders for one printing cylinder which correspond to different operating conditions (for example, for different surface contact pressures).

In order to determine correction values, the offset data used in an optimally configured printing process in the printing press can, for example, be taken into account. Moreover, printing cylinders with applied printing plates by means of which a particularly good or optimum print quality was obtained can be introduced into an aligning device described here and the arrangement of the printing cylinder on the holder and the arrangement of the printing plate on the printing cylinder can be recorded and correction values derived therefrom which can then be used to determine a predetermined position of another printing plate which is to be arranged on this printing cylinder.

The method provides that a first printing cylinder is arranged outside the printing press in a first holding position. The holding position of the printing cylinder outside the printing press preferably corresponds to a printing press position of the printing cylinder inside a printing press.

The printing cylinder in the holding position is preferably arranged on a holder which is designed to hold the printing cylinder, for example by means of a shaft. The holder can preferably move in translation and rotation, possibly driven by servomotors, in order to set a specific holding position of the printing cylinders. The positioning device can also preferably be driven by a drive, in particular by one or more servomotors.

Such a holder preferably essentially corresponds to a holder for the printing cylinder inside a printing press. The first holding position is a specific reproducible position of the first printing cylinder relative to the holder and is preferably fixed with respect to a system of coordinates.

In a next step, a first printing plate is provided and then positioned on the first printing cylinder in a predetermined first position. The positioning described in detail below of the first printing plate on the first printing cylinder can preferably also be applied for the positioning of the second and possibly other printing plates on a second and possibly further printing cylinders.

The predetermined position of a printing plate is preferably defined with respect to a system of coordinates relative to the respective printing cylinder and contains printing-cylinder-specific correction values and specifies in particular the precise desired position of the printing plate on the printing cylinder. If the printing plate is arranged on the printing cylinder in accordance with the predetermined position, there is preferably no need for any subsequent correction of the position.

The positioning preferably takes place via a positioning device. It is moreover preferred that the first printing plate is initially positioned relative to the first printing cylinder in accordance with a predetermined first position and is then arranged or placed in this predetermined first position on the first printing cylinder.

The positioning device preferably used for this positioning can, for example, be a supporting table. The positioning device is preferably defined in its relative position relative to a printing cylinder arranged on the holder in a holding position, i.e. the position of the holding table relative to the holder is preferably known. Moreover, the positioning device is preferably designed so that it can move, in particular at least in two directions of a plane (preferably a horizontal plane) which are orthogonal to each other. It is preferred in particular that a printing plate arranged on the positioning device can be aligned both in translation and in rotation. The positioning device is preferably designed so that it can be driven, in particular by a servomotor. In a particularly preferred alternative embodiment, the positioning device is in two parts, wherein each of the two parts is designed so that it can be moved and driven separately, preferably by a servomotor.

Once the printing plate has been successfully positioned relative to the printing cylinder in the predetermined position, the printing plate can then be applied in this predetermined position to the printing cylinder, i.e. can be arranged or placed on the latter.

The printing plate is first preferably applied to the positioning device in accordance with an approximate position and then detected and recorded in this position. To do this, a control device is preferably used which preferably comprises a camera or image-recognition system and is moreover preferably designed and arranged to detect a reference mark, for example a code or an image portion of the printing plate and to derive a current position of the printing plate relative to the printing cylinder therefrom and to compare this current position with the predetermined position, i.e. a defined target position. If this current position of the printing plate does not coincide with the predetermined position of the printing plate, corresponding additional correction values are preferably determined and the position of the printing plate is changed or corrected accordingly. The correction values are preferably transmitted from the control device to the positioning device so that the positioning device changes the position of the printing plate relative to the printing cylinder by means of corresponding movements derived from the correction values. After such a change or correction to the position of the printing plate, the new position is detected again by the control device or the image-recognition or camera system and compared again with the predetermined position. This preferably takes the form of a management system as defined by a control loop with position detection and position correction until the current position of the printing plate relative to the printing cylinder corresponds to the predetermined position, preferably in the control device. Only then is the printing plate preferably placed or arranged on the printing cylinder in accordance with this predetermined position. The correct positioning of the printing plate arranged on the printing cylinder can then preferably be rechecked by the control device, preferably by the same or an additional image-recognition or camera system. The printing plates are preferably positioned in their predetermined position with a variation of less than one tenth of a millimetre, in particular with a degree of accuracy of +/− five hundredths of a millimetre, in particular with a degree of accuracy of +/− two hundredths of a millimetre.

The preferred embodiment described here of the procedure for positioning a printing plate relative to a printing cylinder, and arranging or placing the printing plate on an outer cylindrical surface of the printing cylinder can preferably be used both for the first printing plate and the first printing cylinder and also for a second printing plate and a second printing cylinder, as well as optionally for further printing plates and further printing cylinders.

The placing of the printing plate on the printing cylinder, after it has been successfully positioned relative to the printing cylinder in the predetermined position, can preferably be facilitated by a specific design of the positioning device or a device for aligning printing plates. After the printing plate has been aligned appropriately relative to the printing cylinder, a first part of the supporting table can preferably be removed in such a way that a first part of the printing plate can be arranged or placed on the printing cylinder, i.e. the printing plate comes into contact with the outer cylindrical surface of the printing cylinder. To do this, a mating cylinder in the form of a roller is preferably provided which can move relative to the printing cylinder and can roll the first part of the printing plate onto the printing cylinder. The second part of the printing plate is preferably arranged or placed on the printing cylinder by the printing cylinder being set in rotation and the printing plate being drawn by the rotation of the printing cylinder between the printing cylinder and a further mating cylinder in the form of a roller of the positioning device, over the outer cylindrical surface of the printing cylinder.

The positioning of the first printing plate on the first printing cylinder is preferably saved by recording the position data.

In a following step, a second printing cylinder is arranged outside a printing press in accordance with a second holding position. This preferably takes place on the same holder on which the first printing cylinder was previously arranged and which was removed from the holder before the second printing cylinder was arranged. A second printing plate is furthermore provided. The properties of the second printing cylinder, the second printing plate and the second holding position preferably correspond to those of the first printing cylinder, the first holding position and the first printing plate.

The second printing plate is positioned relative to the second printing cylinder in a predetermined second position. The processes for positioning described above with respect to the first printing plate, in particular by means of a positioning device designed as a supporting table, are preferably also used correspondingly for positioning the second printing plate.

Before the second printing plate is arranged and placed on the second printing cylinder, their relative position relative to the second printing cylinder is recorded. These recorded second position data are checked with the predetermined second position, preferably by comparing them. The predetermined first position and the predetermined second position are preferably fixed relative to each other, i.e. provided in particular so that they are identical or with a specific translational and/or rotational offset. After the second position data have been recorded, the recorded second position data are compared with the predetermined second position and it is thus checked whether the position data which have actually been recorded coincide with the predetermined position. If this is not the case, the positioning of the second printing plate is corrected. To do this, correction information, on the basis of which the positioning of the second printing plate is then corrected, is preferably determined from checking the second position data with the aid of the first position data, preferably in a procedure corresponding to the preferred process for positioning the printing plate as described above, in particular by moving a positioning device on which the printing plate is arranged.

After positioning the second printing plate and checking its correct positioning and if necessary correcting this positioning, the second printing plate is preferably also arranged or placed on the second printing cylinder, preferably in accordance with the steps and means described above as being preferred.

After applying the first and second printing plates, the actual positions of the applied first and second printing plates can preferably be compared again with the predetermined first and second positions and a warning signal, for example, can be output when the variation exceeds a preset tolerance value, for example 2/100 mm. If the variation is too great, the printing plate can be removed again from the printing cylinder and the positioning procedure for this printing plate is repeated.

It can moreover be preferred to incorporate the following steps into the method: checking the second position data with the aid of the first position data and if necessary correcting the positioning of the second printing plate if the result of the check against the first printing plate is negative. The actual position of the second printing plate applied to the second printing cylinder (determined by the second position data) is hereby compared with the actual position of the first printing plate (determined by the first position data). This checking of the actual position can also be applied correspondingly for more than two printing cylinders and printing plates by further printing plates being aligned relative to further printing cylinders as described above, wherein the respective further position data are then preferably also checked with the aid of the first position data or the respective previous position data, and wherein the further printing cylinders, with the further printing plates arranged thereon, are moreover preferably arranged in accordance with the further holding positions in a printing press.

The method according to the invention has the advantage that the printing plates are already aligned outside the printing press precisely and taking into account printing-cylinder-specific correction values so that there is no need for further registration after the printing cylinders, with the printing plates positioned thereon, have been installed. The tooling times for changing the printed image or pattern can thus be reduced considerably. A further advantage is the ability to reproduce the settings which are needed for a specific printed image.

A further advantage is that the risk of an accident can be reduced considerably because there is no longer any need to adjust printing plate cylinders in the printing press. Moreover, the wastage can be reduced considerably or possibly avoided altogether because the printing plates positioned using the method according to the invention are already aligned relative to one another in such a way that there is no need for any readjustment, or only very small readjustments.

Moreover, the method according to the invention renders mechanical positioning aids such as pins, registration holes or stops superfluous. Because the positioning is preferably effected by detecting a reference mark such as, for example, a graphical element or a code, on the respective printing plates and—when the position of the printing cylinder in the holding position is known—the recorded position of the respective printing plate is compared with a predetermined position and the current position is corrected until it coincides with the predetermined position.

Because this takes place for multiple printing plates on multiple printing cylinders and the relative positions of the respective printing plates relative to one another are compared, an extremely high degree of accuracy can be achieved without there being any need for a test print in the printing press.

Moreover, the degree of process transparency can be increased by a precise and checked alignment and positioning of the printing plates on the printing cylinders outside the printing press. A reason for this is that, when printing errors occur, it is possible to deduce possible sources of errors inside the printing press more quickly because inaccuracies in the application of the printing plates can be avoided by the precise and documentable positioning process, or at least are known and documented.

The method is preferably developed by the step of arranging the first and second printing cylinder with a first or second printing plate arranged thereon in accordance with the first or second holding position in a printing press.

A particular advantage results when, after the printing plates have been aligned precisely and in particular as described also relatively, not only with respect to the respective printing cylinder but also to one another, the printing plates which are finally applied to the printing cylinders are installed in a printing press in order to start the printing there. Because the time to install the printing cylinder, and possibly first remove other printing cylinders, is all that is required hereby, it is possible to change a printed image or pattern particularly quickly and simply and with a reduced risk of injury.

It is in particular preferred that printing plates which are dimensionally stable but can move without warping are used in the method.

In contrast to what is described in, for example, U.S. Pat. No. 5,065,677, in which flexible printing plates such as rubber blocks or photopolymer plates are used, in particular in flexographic printing, in the method described here printing plates are used which, although they can move without warping and hence can be arranged on a cylindrical surface of a printing cylinder, are nevertheless overall dimensionally stable, in particular compared with flexible printing plates such as rubber blocks or photopolymer plates, as are used, for example, in U.S. Pat. No. 5,065,677.

It is particularly preferred that the printing cylinders with the preferably dimensionally stable printing plates positioned thereon are arranged in an offset printing press. Offset printing with dimensionally stable printing plates is preferred in particular for printing the bodies of beverage cans because the dimensionally stable printing plates can move without warping and can hence be arranged without warping on a cylindrical surface of a body. A further advantage of dimensionally stable printing plates is their reusability, i.e. the possibility of reusing used printing plates.

Particularly preferable is an alternative embodiment of the method in which further printing plates are aligned relative to further printing cylinders in accordance with the abovedescribed steps, wherein the respective further position data are checked with the aid of the first position data or the respective previous position data, and wherein moreover the further printing cylinders with the further printing plates arranged thereon are preferably arranged in accordance with the further holding positions in a printing press, as described above.

Preferably as many printing plates are aligned and arranged on as many printing cylinders as are required for a printing. The required number here depends in particular on the number of inks used to print a desired printed image.

The advantageous designs and embodiments, detailed in the description above or below, with a first and second printing cylinder with first and second printing plates, apply in a corresponding fashion also for alternative embodiments of the method with three or more further printing plates and printing cylinders.

A further preferred embodiment of the method is characterized by the steps of reading identification data of the first printing cylinder, and reading identification data of the second printing cylinder, wherein the identification data in each case contain the first and second holding position, respectively.

Identification data of the printing cylinders are used in this alternative embodiment of the method. These identification data preferably serve to unambiguously identify a printing cylinder. The identification data can contain, for example, a unique identification number of a printing cylinder and/or information on the position of the printing cylinder in the printing press, associated inking units, etc. It is preferred in particular that the identification data include the holding position of the printing cylinder. As explained above, the holding position of a printing cylinder is preferably a specific position of the printing cylinder in the holder, which is fixed unambiguously with respect to a system of coordinates. This specific position information of the printing cylinder in which it is arranged in the holder before the printing plate is aligned is preferably contained in the identification data.

The identification data of the printing cylinder can be saved, for example, in a storage device which is connected to a device for aligning printing plates on printing cylinders and can be read accordingly. The identification data can be associated with a specific printing cylinder, for example, by a user selecting the appropriate information dataset, or can be output by the system accordingly after a user has input a specific identifier of a printing cylinder. It is, however, particularly preferred that a printing cylinder bears an identifying mark which can be registered by a user but preferably by a detection device. The data which are read in this process can either contain the complete identification data or alternatively be linked to saved associated identification data so that there is complete identification information for the subsequent method. The detection device can, for example, be an image-recognition or camera system and preferably be part of the control device or be connected to the latter. The detection device can if appropriate be the same image-recognition or camera system as was used for the process of aligning the printing plates.

Each printing cylinder moreover preferably also bears a position mark by means of which the precise alignment of the respective printing cylinder in its respective printing unit can be determined. A respective printing cylinder correction value, and hence ultimately the respective predetermined position for a printing plate on the respective printing cylinder, can thus be determined.

In a preferred embodiment, the method moreover comprises the step of linking the identification data of the first and the second printing cylinder to the saved predetermined correction values, preferably to the printing-cylinder-specific correction values, for positioning the printing plates on the respective printing cylinder.

In this embodiment, correction values, preferably the printing-cylinder-specific correction values which are taken into account when aligning the printing plates, are linked to the identification data. The respective correction values can consequently automatically be made available when detecting or identifying the printing cylinder in particular in order to change the predetermined position by the correction values and/or, after the printing plate has been aligned in accordance with the predetermined position, to change the position of the printing plate again by additional correction values. To do this, the correction values are preferably processed in a control device or management device and linked to the predetermined positions or transmitted as separate corrective information to the positioning device.

If information about such an offset, here referred to as a correction value, can be linked to the identification data or is already contained in these identification data, when the printing plates are aligned this offset can be taken into account particularly simply, preferably in an automated and/or software-assisted manner.

It is moreover preferred that the first or second printing plate has a code, preferably a graphical element and/or a 2D barcode such as, for example, a Data Matrix code, a QR code, a MaxiCode or an Aztec code, which is used for positioning the first or second printing plate.

Such a code can be applied easily to the printing plate when the relief printing matrix is applied, and can be arranged in the printed image itself or at a different point of the printed plate. The code can be a simple graphical element such as, for example, a rectangle, or a more complex 2D barcode. A Data Matrix code in the form of an RCC 9 (Register Computer Control) code can in particular be used. Such a code can be easily and reliably detected by a control device, for example an image-recognition or camera system, and be evaluated with respect to the position.

The positioning mark on a respective printing cylinder can also be a graphical element or a 2D barcode, for example a Data Matrix code.

Other preferred steps of an embodiment of the method are simulating a print with the first and second printing cylinder with positioned first and second printing plates outside a printing press, and displaying the result of the simulation, in particular in the form of a deviation from the register marks and/or as a virtual printed image.

In this embodiment of the method, a virtual print is still carried out outside the printing press, i.e. the actual printing process and the print quality are simulated. This is preferably effected using the recorded position data of the printing plates arranged on the printing cylinders. In this way, in particular together with information on the position of the printing cylinders in the printing press and the recorded position data of the printing plates, the quality of the actual printing that will be obtained can be determined. For such a simulation, specific inking information is preferably linked for each printing plate with the aid of its position and preferably with the aid of information, which exists for the printing cylinder on which it is arranged, on the corresponding inking unit, and a virtual first printed image, a so-called virtual initial proof or initial can, is created. This procedure can also be referred to as a PDF comparison as the result is generated as a PDF document. If it is detected in this simulation that there is a need for further corrections, these can likewise be addressed outside the printing press and corrected accordingly before the printing cylinder is installed in a printing press and checked by another simulation. In this way, the reliability of the alignment process can be increased further and hence also the accuracy of the printing process which ultimately takes place in the printing press so that there is as little wastage as possible in the actual printing in the printing press.

It is moreover particularly preferred to carry out the step of determining and outputting an action for correcting the positioning of the second printing plate if the result of the check and/or the result of the simulation is or are negative.

In this alternative embodiment, it is preferred that, when checking the second position data with the aid of the first position data and/or when evaluating the result of the simulation, not only is the need for correction detected but at the same time one or more actions are determined and indicated by means of which the deviation can be rectified. This is advantageous because, owing to the number of printing plates and printing cylinders and the respective positioning, there are multiple options for correction but these can result in a further deterioration of the result if there is an improper change in the positioning. The automatic determining and outputting of corrective actions therefore has the advantage that a correction can be made in a targeted fashion and using as few actions as possible. Information on a corrective action preferably contains a statement as to which printing plate, for example the second one, third one or further ones, needs or need to be corrected and which changes to position need to be carried out to achieve this, preferably by which movements of the positioning device, in order to improve the result.

A further preferred embodiment provides that the first or second printing plate is held on the first or second printing cylinder, respectively, in the predetermined first or second position, respectively, by magnetic force, preferably exclusively by magnetic force.

Such a magnetic fastening of the printing plates on the printing cylinders has the advantage that there is no need for any mechanical position retention points or clamps for fastening the printing plates on the printing cylinders. In this way, the positioning of a printing plate on a printing cylinder is also not fixed or limited by such mechanical retention points.

It is here in particular preferred that the first printing cylinder and/or the second printing cylinder and/or one or more of the further printing cylinders has or have a magnetic or magnetizable material.

A printing cylinder can, for example, have one or more permanent magnets, or be designed as such magnets. A printing cylinder can moreover be designed as an electromagnet with a magnetic field that can be switched on and off.

It is in particular preferred that, during the positioning of a printing plate relative to a printing cylinder, there is only the lowest possible magnetic effect, or none at all, between the printing cylinder and printing plate in order to influence as little as possible, or not at all, the alignment and positioning process. It is preferred that there is a corresponding magnetic effect only once the printing plate has been successfully aligned relative to the printing cylinder and shortly before the printing plate is then to be applied to the printing cylinder in this predetermined position and arranged or placed on the latter. The magnetic effect during the alignment or positioning process can be reduced, for example, by an insulation, a counteracting magnetic field or switching off a printing cylinder designed as an electromagnet.

It is particularly preferred that the first printing plate and/or the second printing plate and/or one or more of the further printing plates has or have a magnetic material, wherein preferably in the form of a steel plate strap. This design of the printing plates makes them suitable in a particularly simple and efficient manner for fastening to a printing cylinder using magnetic force.

To achieve a high-quality printing process, it is moreover preferred to carry out the step of rounding a first and/or a second edge of the first and/or second printing plate. A particularly clean printed image can be generated by rounding the edges, also known as canting.

It is moreover preferred to carry out the step of rolling the first or second printing plate onto the first or second printing cylinder. As already described above, it is preferred to roll the printing plate onto the printing cylinder, in particular in combination with fastening by means of magnetic force. The rolling preferably takes place in such a way that a previous positioning of the printing plate in a specific position relative to the printing cylinder is maintained during the rolling.

An embodiment of the method is in particular preferred which has the step of widening an opening and/or registration hole or multiple openings and/or registration holes of the first and/or second printing plate, preferably by increasing the diameter of recesses of the opening or openings by at least 2 millimetres or by increasing the length and/or width of the registration hole(s) by at least 2 millimetres.

With this step the method becomes applicable in particular also for printing plates and printing cylinders which were originally designed for alignment and positioning using mechanical means such as, for example, register pins. In order to provide a greater degree of flexibility than with such mechanical positioning and alignment, the respective mechanical register features of the printing plate are preferably widened such that they have a greater tolerance than the respective associated registration features of a printing cylinder and can therefore be positioned more flexibly than these registration features of a printing cylinder.

It is moreover particularly preferred that the provision of the first or second printing plate includes laying the first or second printing plate on a supporting area of a supporting table.

As already described above, it is preferred that the printing plates are applied to a positioning device at the beginning of the positioning procedure, in particular are laid on a supporting table. This can preferably be performed manually by a user. Because, as also described above, it is not necessary to lay the printing plates on the positioning device for the first time with the required degree of accuracy yet, as the method detects the position of the printing plate and then aligns it accordingly, a printing plate can be laid manually on a positioning device.

In a further preferred embodiment of the method, the step is provided of changing the first or second holding position of the first or second printing cylinder by a first or second offset. It is particularly preferred here that the first or second identification data contain information on the first or second offset.

As an expansion or an alternative to the abovedescribed software-based correction, it is also possible to carry out a so-called hardware-based correction. The holding position of the printing cylinder is here corrected by the corresponding offset before the beginning of the alignment process. The printing plate is then, as described, positioned accordingly relative to the printing cylinder already arranged in a corrected holding position, and applied to said printing cylinder.

The purpose and results of the software-based and hardware-based correction preferably correspond: in both correction options, corrective information is first provided so that this correction is already taken into account in the result, namely of the printing plate positioned on a printing cylinder and the printing thus obtained, without there being any need to correct it subsequently. Whereas, in the software-based correction, this is obtained purely by changing the position data of the printing plate, the hardware-based correction also performs a change in the position of the printing cylinder, preferably by corresponding options for adjusting the holder.

According to a further aspect of the invention, the abovementioned object is achieved by a device for aligning printing plates on printing cylinders outside a printing press, comprising a holder for arranging a printing cylinder outside a printing press in a holding position, a positioning device for positioning a printing plate on a printing cylinder, arranged in the holder, in a predetermined position, a control device for recording position data of a printing plate which is positioned relative to a printing cylinder arranged in the holder, wherein the control device is designed to check second position data of a second printing plate, which is positioned relative to a second printing cylinder arranged in the holder in accordance with a second holding position, with the aid of first position data of a first printing plate, which is positioned on a first printing cylinder arranged in the holder in accordance with a first holding position, and to output a result of the check.

It is preferred that the positioning device comprises a supporting table which is connected to the holder for arranging a printing cylinder.

A further preferred alternative embodiment provides that the positioning device comprises one, two or more mating cylinders which is or are designed and arranged so as to roll a printing plate onto a printing cylinder arranged in the holder in accordance with a holding position.

It is moreover preferred that the positioning device and/or a rounding device is designed and arranged so as to round a first and/or a second edge of one, two or more printing plates.

Lastly, the device is preferably developed by the positioning device and/or a widening device being designed and arranged so as to widen one or more openings and/or registration holes of the first and/or second printing plate, preferably by increasing the diameter of recesses of the opening or openings by at least 2 millimetres or by increasing the length and/or width of the registration hole(s) by at least 2 millimetres.

The device according to the invention and its developments have further features which in particular make it suitable for executing the method according to the invention and its developments.

For the advantages, alternative embodiments and detailed embodiments of the device and its developments, reference is made to the preceding description for the corresponding developments of the method.

Preferred embodiments of the invention are described by way of example with the aid of the attached drawings, in which:

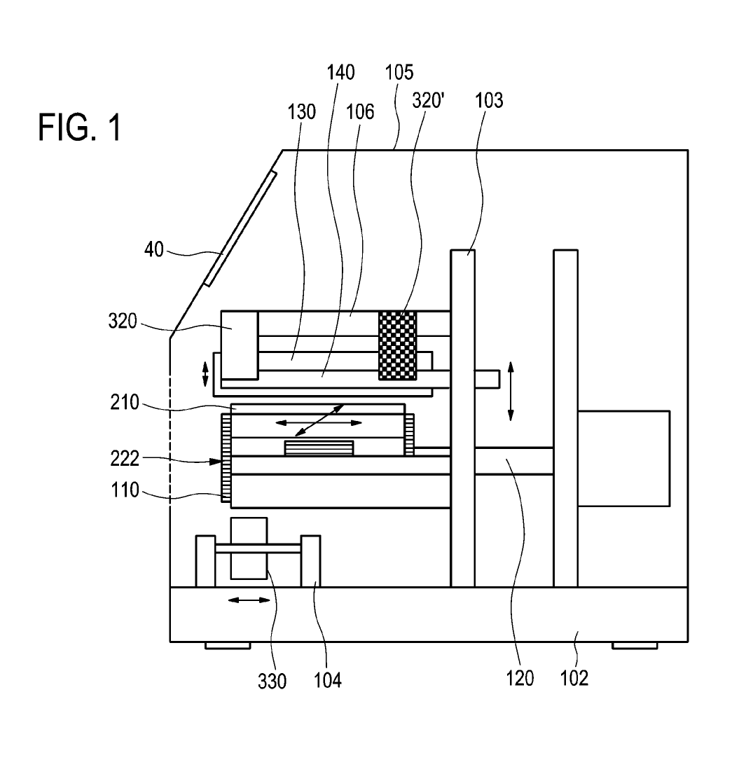

FIG. 1 shows a cross section through a schematic view of an embodiment, given by way of example, of a device according to the invention;

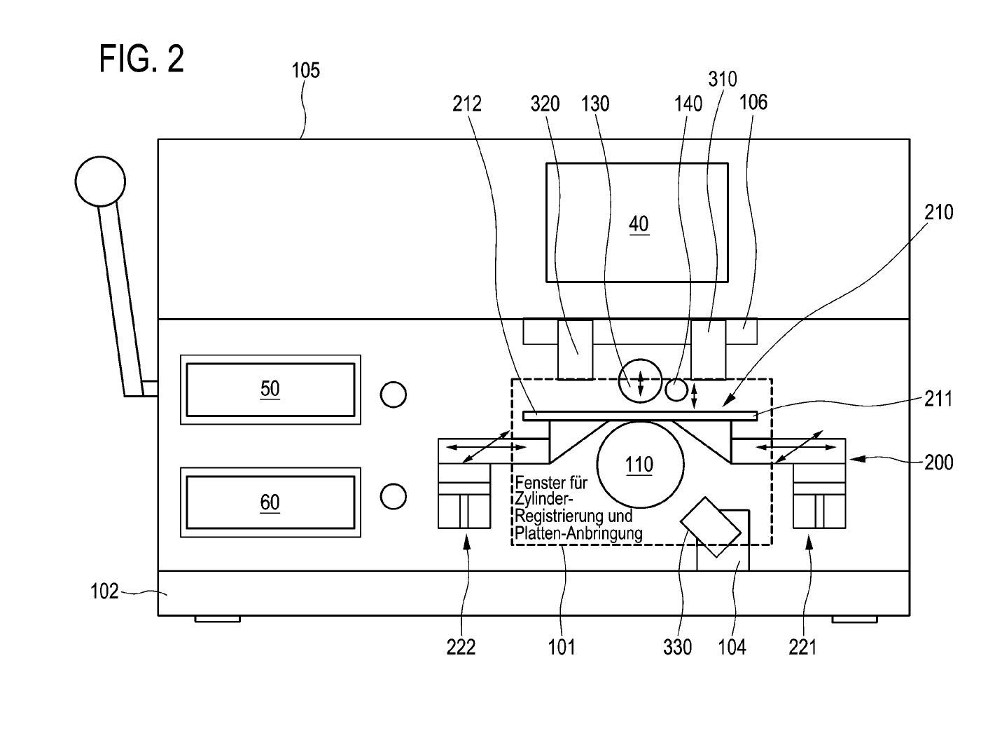

FIG. 2 shows a front view of the device according to FIG. 1;

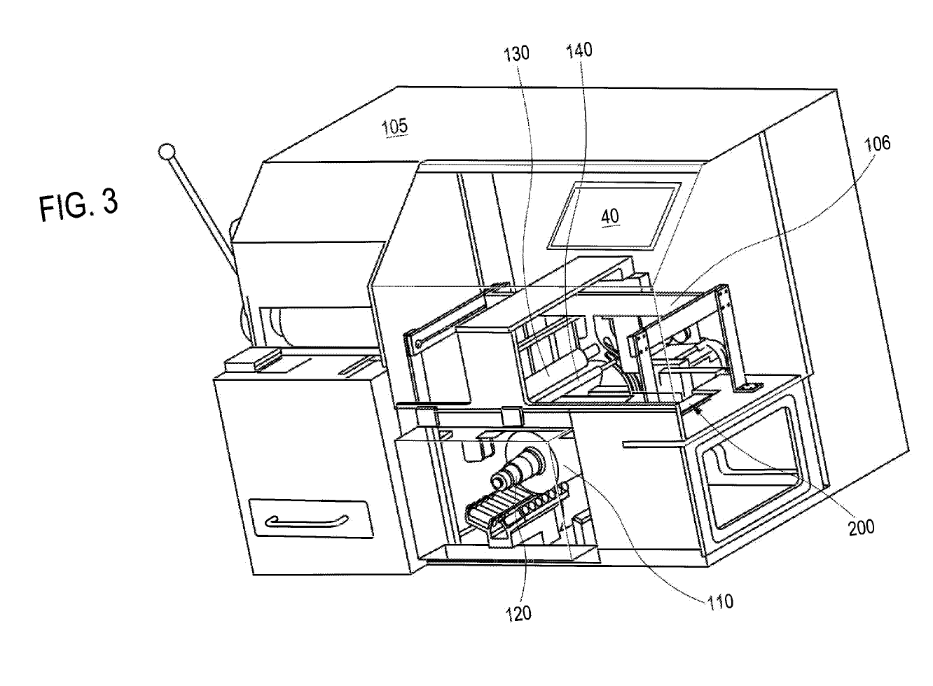

FIG. 3 shows a first three-dimensional view of the device according to FIG. 1; and

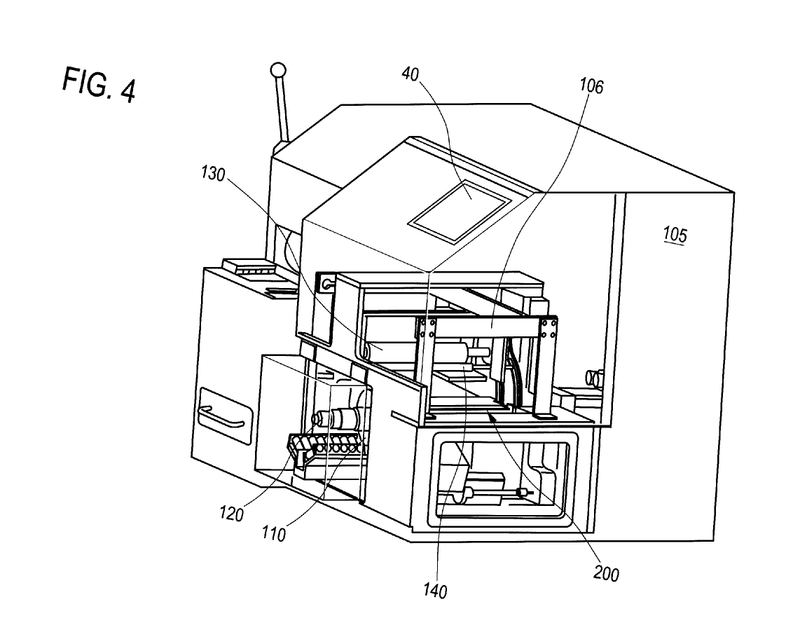

FIG. 4 shows a second three-dimensional view of the device according to FIG. 1.

The schematic view shown in FIGS. 1 to 4 of an embodiment, given by way of example, of a device 100 according to the invention for aligning printing plates on printing cylinders outside a printing press is designed to carry out the method according to the invention for aligning printing plates on printing cylinders outside a printing press. The device 100 has a baseplate 102 and an outer cover 105. An operating panel 40, in the form of a touch-screen display, is arranged in the outer cover 105.

Frames 103, 104 for positioning different elements of the device 100 are arranged in the device 100. A holder 120 in the form of a shaft, on which a printing cylinder 110 is arranged in a holding position, is fastened to the frame 103.

Printing plates (not shown) are aligned in the device 100 in such a way that they can be arranged on a printing cylinder 110 in a predetermined position. The alignment and positioning process takes place in particular with a window, labelled with the reference numeral 101, of the device 100. The device 100 has a positioning device 200 on which a printing plate can be laid preferably manually by a user. The positioning device 200 is here designed as a supporting table 210 which is designed so that it can be moved via adjustment mechanisms 221 and 222. The positioning device can preferably move in particular in two directions, lying at right angles to each other, within a plane, preferably a horizontal plane, as indicated here by the four arrows of the adjustment mechanisms 221, 222. The supporting table 210 preferably has a two-part design, wherein each of the two parts 210, 212 are designed so that they can be moved and driven separately, preferably by one or more servomotors.

The device 100 has an image-recognition or camera system which is here equipped with three cameras 310, 320, 330 in all. The camera system is preferably part of a control device. The cameras 310, 320 are fastened to the frame 103, 106 and can move. A possible alternative position of the camera 320 is shown by 320′0 in FIG. 1. The cameras 310, 320 serve to detect a code applied to the printing plate and to determine therefrom the position of the printing plate on the supporting table 210 relative to the printing cylinder 110.

The device 100 preferably has a control device or management unit which is designed so as to evaluate the position of the printing plate on the supporting table 210 recorded by the cameras 310, 320, to compare it in particular with a predetermined position and to determine correction values therefrom and in turn to activate the adjustment mechanisms 221 and 222 of the positioning device 200 using these correction values in such a way as to bring the position of the printing plate on the supporting table 210 relative to the printing cylinder 110 closer to the predetermined position. As defined by a control loop, the position of the printing plate on the supporting table 210 is detected by the control device or the cameras 310, 320, the current and the predetermined position are compared, and the current position is corrected by the positioning device 200 until the printing plate on the supporting table 210 has assumed the predetermined position relative to the printing cylinder 110.

During this alignment and positioning process, it is advantageous if no high magnetic forces act on the printing plate in order to facilitate the alignment and positioning of the printing plate. To do this, the supporting table 210 can be made from a magnetically insulating material. Alternatively or additionally, a printing cylinder 110 can be designed as an electromagnet and preferably be switched off during the alignment and positioning process or an additional magnetic field counteracting the magnetic effect of the printing cylinder 110 can be set up.

After the first printing plate has been aligned in the predetermined position relative to the printing cylinder 110 in such a way, a first part 211 of the supporting table 210 is preferably removed from its position shown in the drawings, for example by pivoting. The part of the printing plate which has been laid on this first part 211 of the supporting table 210 is then rolled onto the cylindrical surface of the printing cylinder 110 by the roller 140. To do this, the roller 140 moves vertically downwards towards the printing cylinder 110 and preferably runs clockwise along the cylindrical surface of the printing cylinder 110 until the part of the printing plate has been applied completely by the roller. The roller 140 then moves back into its original position.

In order also to arrange the second part of the printing plate, which is still situated on the second part 212 of the supporting table 210, on the printing cylinder 110, the pressure roller 130 on the one hand moves downwards and moreover the printing cylinder 110 is set into clockwise rotational movement so that the second part of the printing plate is drawn between the pressure roller 130 and the outer cylindrical surface of the printing cylinder 110 by the rotational movement of the printing cylinder 100, downwards from the supporting table 210 and onto the cylindrical surface of the printing cylinder 110.

When the printing cylinder 110 rotates clockwise in this way, the printing plate which is now arranged on the printing cylinder 110 passes the camera 330 which is arranged and designed so as to record position data of the printing plate after it has been laid on the printing cylinder 110 and/or to record position data of the printing cylinder 110, preferably by reading a graphical element or code on the printing cylinder. These data are also preferably saved and are made available to the control device or management device. In order to detect the position of the printing plate positioned on the printing cylinder 110 or of the printing cylinder 110 itself, the camera 330 can, as shown in FIG. 1, be displaced horizontally towards the cylinder axis of the printing cylinder 110 along the frame 104.

The printing plate is preferably fastened to the printing cylinder 110 exclusively by magnetic force. A magnetic field of the printing cylinder, which is neutralized, switched off or insulated during the alignment and positioning of the printing plate, preferably becomes active when the printing plate is to be placed after successful alignment and positioning on the outer cylindrical surface of the printing cylinder.

The process of aligning and positioning the second printing plate on a second printing cylinder takes place essentially as described above for a first printing plate and a first printing cylinder. When a second or further printing plate is aligned and positioned on a second or further printing cylinder, the current position of the printing plate is compared with a predetermined position when the printing plate is aligned and positioned, and if necessary the alignment or positioning is corrected depending on this check.

The device 100 moreover has two modules 50, 60 which serve to prepare the printing plates for the alignment and positioning device. In the module 50, the edges of the printing plates can be bent, in particular canted or rounded. When necessary, existing openings or registration holes or similar mechanical positioning aids can be widened in the module 60 so that a subsequent alignment and positioning can be effected independently of the constraints represented by mechanical positioning aids.

The device 100 shown is designed so as to arrange in each case a printing plate on a printing cylinder 110. After the printing plate has been arranged on the printing cylinder 110, the printing cylinder is replaced by a new printing cylinder which is then for its part provided with a printing plate. After printing plates have been positioned and arranged on the printing cylinders 110, these printing cylinders 110 are preferably inserted in a printing press.

As an alternative to the device 100 shown here, devices can also be used which provide a simultaneous alignment and positioning of multiple printing plates on multiple printing cylinders.

The device 100 shown here can be arranged, for example, in proximity to a production line for producing beverage cans, preferably in proximity to a can printing press or a so-called decorator. With the device 100 shown, all of the printing plates required for a specific printed image can be placed on printing cylinders with the desired degree of accuracy, and to be precise outside a printing press and temporally independently of the start of the production process of the cans with this specific printed image. When cans with the specific printed image are then to be produced in the production line, all that is required in the can printing press is to replace the printing cylinders for the printing cylinders already provided with the corresponding printing plates. A high-quality printed image can be generated, right from the start of the production line, by the printing plates which are already aligned relative to one another on the printing cylinders with a high degree of accuracy, without there being any need for complex readjustments which are connected with a high degree of wastage.

1. A method for aligning printing plates on printing cylinders outside a printing press, comprising:
a. determining predetermined first and second positions with the aid of previously determined printing-cylinder-specific correction values for a first and a second printing cylinder,
b. arranging the first printing cylinder outside a printing press in a first holding position,
c. providing a first printing plate,
d. positioning the first printing plate on the first printing cylinder in a predetermined first position,
e. recording first position data for the first printing plate positioned on the first printing cylinder,
f. arranging the second printing cylinder outside a printing press in accordance with a second holding position,
g. providing a second printing plate,
h. positioning the second printing plate relative to the second printing cylinder in a predetermined second position,
i. recording second position data for the second printing plate positioned relative to the second printing cylinder,
j. checking the first and second position data with the aid of the predetermined first and second position,
k. if necessary correcting the positioning of the first and/or the second printing
plate if the result of the check is negative.

2. The method of claim 1, comprising:
1. arranging the first and second printing cylinders, with first and second printing plates arranged respectively thereon in accordance with the first and second holding positions, respectively, in a printing press.

3. The method of claim 1, wherein the printing plates are dimensionally stable but can move without warping.

4. The method of claim 1, wherein additional printing plates are aligned relative to further printing cylinders and wherein the respective further position data are preferably checked with the aid of the predetermined further position, and wherein moreover the further printing cylinders, with the further printing plates arranged thereon, are moreover preferably arranged in accordance with the further holding positions in a printing press in accordance with step 1.

5. The method of claim 1 further comprising:
reading identification data of the first printing cylinder;
reading identification data of the second printing cylinder; and
wherein the identification data in each case contain the first and second holding position, respectively.

6. The method of claim 1, further comprising:
linking the identification data of the first and the second printing cylinder to the saved predetermined correction values, preferably to the printing-cylinder-specific correction values, for positioning the printing plates on the respective printing cylinder.

7. The method of claim 1, wherein the first or second printing plate has a code, preferably a graphical element and/or a 2D barcode; including but not limited to at least one of a Data Matrix code, a QR code, a MaxiCode or an Aztec code, which is used for positioning the first or second printing plate.

8. The method of claim 1, further comprising:
simulating a print with the first and second printing cylinders with positioned first and second printing plates outside a printing press; and
displaying the result of the simulation, in particular in the form of a deviation from the register marks and/or as a virtual printed image.

9. The method of claim 1, further comprising:
determining and outputting an action for correcting the positioning of the second printing plate if the result of the check and/or the result of the simulation is negative.

10. The method of claim 1, wherein the first or second printing plate is held on the first or second printing cylinder, respectively, in the predetermined first or second position, respectively, by a magnetic force.

11. The method of claim 1, wherein at least one of the first printing cylinder and the second printing cylinder and the further printing cylinders is comprised of a magnetic or magnetizable material.

12. The method of claim 1, wherein at least one of the first printing plate and the second printing plate and one or more of the further printing plates is comprised of a steel plate strap.

13. The method of claim 1, further comprising:
rounding a first and/or a second edge of the first and/or second printing plate.

14. The method of claim 1, further comprising:
rolling the first or second printing plate onto the first or second printing cylinder.

15. The method of claim 1, further comprising
widening an opening and/or registration hole or multiple openings and/or registration holes of the first and/or second printing plate, preferably by increasing the diameter of recesses of the opening or openings by at least 2 millimetres or by increasing the length and/or width of the registration hole(s) by at least 2 millimetres.

16. The method of claim 1, wherein the provision of the first or second printing plate includes laying the first or second printing plate on a supporting area of a supporting table.

17. The method of claim 1, further comprising
changing the first or second holding position of the first or second printing cylinder by a first or second offset.

18. The method of claim 1, wherein the first or second identification data contain information on the first or second offset.

19. A device for aligning printing plates on printing cylinders outside a printing press, comprising
a holder for arranging a printing cylinder outside a printing press in a holding position;
a positioning device for positioning a printing plate on a printing cylinder, arranged in the holder, in a predetermined position;
a control device for recording position data of a printing plate which is positioned relative to a printing cylinder arranged in the holder; and
wherein the control device is designed to check a second position data of a second printing plate, which is positioned relative to a second printing cylinder arranged in the holder in accordance with a second holding position, with the aid of the first position data of a first printing plate, which is positioned on a first printing cylinder arranged in the holder in accordance with a first holding position, and to output a result of the check.

20. The device of claim 19, wherein the positioning device comprises a supporting table which is connected to the holder for arranging a printing cylinder.

21. The device of claim 19, wherein the positioning device comprises at least one mating cylinders which is or are designed and arranged so as to roll a printing plate onto a printing cylinder arranged in the holder in accordance with a holding position.

22. The device of claim 19, wherein the positioning device and/or a rounding device is designed and arranged so as to round a first and/or a second edge of one, two or more printing plates.

23. The device of claim 19, wherein the positioning device and/or a widening device is designed and arranged so as to widen one or more openings and/or registration holes of the first and/or second printing plate, preferably by increasing the diameter of recesses of the opening or openings by at least 2 millimetres or by increasing the length and/or width of the registration hole(s) by at least 2 millimetres.
